(19) United States
(12) Patent Application Publication
(10) Pub. No.: US 2004/0187101 A1
(43) Pub. Date: Sep. 23, 2004

(54) Compiler, compiler program, recording medium, and compiling method

(75) Inventors: Tatsushi Inagaki, Yokohama-shi (JP); Hideaki Komatsu, Yokohama-shi (JP)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY

(21) Appl. No.: 10/731,839

(22) Filed: Dec. 9, 2003

(30) Foreign Application Priority Data
Mar. 19, 2003 (JP) 2003-074834

(51) Int. Cl. G06F 9/45; G06F 15/00

(52) U.S. Cl. 717/159; 717/140; 712/226

(57) ABSTRACT

A compiler that optimizes a program to be compiled includes: an order constraint information obtaining unit that obtains order constraint information defined among a plurality of instructions; an order determination unit that sequentially determines the execution order for each of the plurality of instructions based on the order constraint information; a unit for analyzing the number of registers that analyzes the number of required registers, which is the number of registers that will be required when the instructions with its execution order determined are executed; an instruction detection unit that detects a combination of two instructions, in which one instruction is a determined-order instruction, the other instruction is an undetermined-order instruction, and the order constraint information does not include a constraint that the one instruction should be executed before the other instruction; and an order determination reprocessing unit that, when the number of required registers exceeds a predetermined number, changes the state of the one instruction into the state in which the execution order has not been determined and causes the execution order to be determined so that the one instruction is executed next to the other instruction.

### FIELD AND BACKGROUND OF INVENTION

The present invention relates to a compiler, a compiler program, a recording medium, and a compiling method. In particular, the invention relates to a compiler, a compiler program, a recording medium, and a compiling method for optimizing a program by changing the execution order of instructions.

An instruction scheduler that can reduce the number of registers used by a program has been proposed (see R. Govindarajan, Hongbo Yang, Chihong Zhang, and Guang R. Gao, “Minimum Register Instruction Sequence Problem: Revisiting Optimal Code Generation for DAGs”, International Parallel and Distributed Processing Symposium proceedings, April 2001). This scheduler performs graph coloring to analyze the minimum number of registers to be used, enabling to appropriately determine the execution order of instructions and accelerate operation of a program to be compiled.

However, in the above technique, more registers might be required than analyzed by graph coloring. As a result, if the number of required registers exceeds the number of registers in a computer, operations have to be done using memory, which is slower than the registers and therefore impairs efficiency.

Thus, one purpose of the invention disclosed hereinafter is to provide a compiler, a compiler program, a recording medium, and a compiling method that can solve this problem. This purpose is achieved by combinations of features set forth in independent claims. In addition, dependent claims define further advantageous implementations of the invention.

### SUMMARY OF THE INVENTION

According to a first embodiment of the invention, a compiler that optimizes a program to be compiled by changing the execution order of instructions in the program is provided, wherein the compiler comprises: an order constraint information obtaining unit that obtains order constraint information indicating order constraints defined among a plurality of instructions in the program, the order constraint defining the order in which the instructions should be executed; an order determination unit that sequentially determines the execution order for each of the plurality of instructions based on the order constraint information; a unit for analyzing the number of registers that analyzes the number of required registers, which is the number of registers that will be required when the instructions with its execution order determined among the plurality of instructions are executed; an instruction detection unit that detects a combination of two instructions, in which one instruction is a determined-order instruction for which the execution order has been determined by the order determination unit, the other instruction is an undetermined-order instruction for which the execution order has not been determined by the order determination unit, and the order constraint information does not include a constraint that the one instruction should be executed before the other instruction; and an order determination reprocessing unit that, when the number of required registers exceeds a predetermined number, changes the state of the one instruction into the state in which the execution order has not been determined and causes the order determination unit to determine the execution order so that the one instruction is executed next to the other instruction. The invention also provides a compiling method, a compiler program, and a recording medium.

It is to be noted that not all features listed in the above summary of the invention are essential to the invention, but subcombinations of these groups of features may also be included in the invention.

### BRIEF DESCRIPTION OF DRAWINGS

Some of the purposes of the invention having been stated, others will appear as the description proceeds, when taken in connection with the accompanying drawings, in which:

FIG. 1 shows a functional block diagram of a compiler 10;

FIG. 2 shows a flowchart of the compiler 10;

FIG. 3 shows an exemplary order constraint graph stored in an order constraint graph storage unit 105 by an order constraint obtaining unit 100;

FIG. 4 shows exemplary order constraints added by an order determination unit 110;

FIG. 5 shows an example of the number of required registers analyzed by the order determination unit 110;

FIG. 6(a) shows an exemplary order constraint added by an order determination reprocessing unit 140;

FIG. 6(b) shows a set of allocate instructions to which a further register is allocated, and a set of release instructions that release a register;

FIG. 7(a) shows exemplary determination of the execution order of instructions in a first alternative example;

FIG. 7(b) shows a graph indicating whether sets of instructions in the first alternative example can share the registers; and

FIG. 8 shows an exemplary hardware configuration of the compiler 10 according to an embodiment

### DETAILED DESCRIPTION OF INVENTION

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

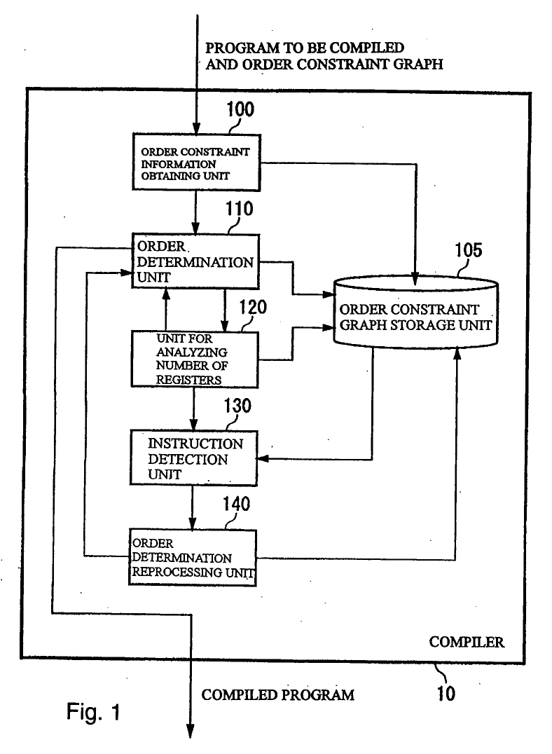

FIG. 1 shows a functional block diagram of a compiler 10. The compiler 10 is a device for optimizing the execution order of instructions, and it is characterized by canceling the execution order once determined and reprocessing determination of the execution order as needed in the process of sequential determination of the execution order of instructions. The compiler 10 includes an order constraint obtaining unit 100, an order constraint graph storage unit 105, an order determination unit 110, a unit for analyzing the number of registers 120, an instruction detection unit 130, and an order determination reprocessing unit 140.

The order constraint obtaining unit 100 obtains a program to be compiled, as well as order constraint information that indicates order constraints defined among a plurality of instructions in the program: the order constraints define the order in which the instructions should be executed. For example, as the order constraint information, the order constraint obtaining unit 100 obtains an order constraint graph that represents each instruction in the program as a node and represents order constraints under which the instructions should be executed as directed edges. The order constraint obtaining unit 100 stores the order constraint graph in the order constraint graph storage unit 105 sand informs the order determination unit 110 of the reception of the program.

The program to be compiled is an intermediate representation, such as bytecode in Java (registered trademark), generated from a source program for efficient optimization. Alternatively, the program may be in RTL (Register Transfer Language) or may be a quadruple representation. The program may be an entire program to be executed by a user or may be a module that represents one of features of the program. A module may be, for example, a method, a function, or a procedure. Alternatively, a module may be a Basic Block, which is a set of instructions including the initial instruction, the last instruction, and remaining instructions that are neither branch instructions nor destinations of branch instructions. An instruction is a unit of process that constitutes a part of the above described intermediate representation and instructs a computer to perform a processing task. For example, an instruction may be a computer instruction or a set of instructions.

Upon informed by the order constraint obtaining unit 100 of the reception of the program to be compiled, the order determination unit 110 obtains the order constraint graph from the order constraint graph storage unit 105. The order determination unit 110 then determines the execution order for each of the instructions based on the order constraint graph. For example, the order determination unit 110 determines the execution order in the following manner each time it is directed to continue determination of the execution order of instructions by the unit for analyzing the number of registers 120. First, on the order constraint graph, the order determination unit 110 selects a node where the execution order has been determined for all preceding nodes to be executed before the node. Then, the order determination unit 110 determines the execution order so that an instruction represented by the selected node is executed next to the instructions with their execution order determined. The order determination unit 110 informs the unit for analyzing the number of registers 120 of the determined execution order. That is, the order determination unit 110 determines the execution order based on the order constraint graph so that an instruction represented by the start node of a directed edge is executed before an instruction represented by the end node of the directed edge.

The order determination unit 110 may also be directed by the order determination reprocessing unit 140 to change the state of an instruction into the state in which the execution order has not been determined. In this case, for that instruction and instructions to be executed after that instruction with their execution order determined, the order determination unit 110 changes their state into the state in which the execution order has not been determined. Then, the order determination unit 110 performs the above described processing of order determination.

The unit for analyzing the number of registers 120 receives the execution order from the order determination unit 110. Based on the order constraint graph obtained from the order constraint graph storage unit 105, the unit for analyzing the number of registers 120 analyzes the number of required registers, which is the number of registers that will be required if instructions with their execution order determined are executed. If the number of required registers exceeds a predetermined number of registers, the unit for analyzing the number of registers 120 informs the instruction detection unit 130 of the excess of the number of registers. On the other hand, if the number of required registers does not exceed the predetermined number of registers, the unit for analyzing the number of registers 120 directs the order determination unit 110 to continue determination of the execution order of instructions.

The instruction detection unit 130 obtains the order constraint graph from the order constraint graph storage unit 105. If the instruction detection unit 130 is informed of the excess of the number of registers by the unit for analyzing the number of registers 120, it detects a combination of two instructions that meets the following conditions: one of the two instructions is a determined-order instruction for which the execution order has been determined by the order determination unit 110 and which requires a new register; the other instruction is an undetermined-order instruction for which the execution order has not been determined by the order determination unit 110 and which releases a register allocated to it; and the order constraint information does not include an order constraint that the one instruction should be executed before the other instruction. Specifically, the instruction detection unit 130 detects a combination of instructions in which a node representing the one instruction cannot reach a node representing the other instruction on the order constraint graph. This allows detection that the order constraint information does not include an order constraint that the one instruction should be executed before the other instruction.

The order determination reprocessing unit 140 generates a directed edge from the node representing the other instruction to the node representing the one instruction. This adds a constraint that the one instruction should be executed next to the other instruction to the order constraint information. Further, the order determination reprocessing unit 140 informs the order determination unit 110 that the state of the one instruction is changed into the state in which the execution order has not been determined. Therefore, the order determination reprocessing unit 140 changes the state of the one instruction and all instructions to be executed after the one instruction into the state in which the execution order has not been determined. Then, it can cause the order determination unit 110 to determine the execution order so that the one instruction is executed next to the other instruction.

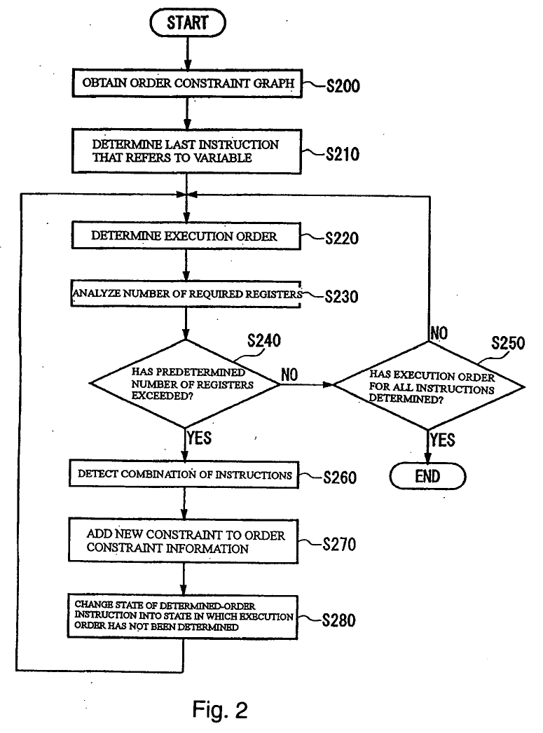

FIG. 2 shows a flowchart of the compiler 10. The order constraint obtaining unit 100 obtains the order constraint graph (S200). Then, the order determination unit 110 adds new order constraints to the obtained order constraint graph as needed (S210). For example, the order determination unit 110 detects a preceding node that has following nodes to be executed after the preceding node on the order constraint graph. It then selects, from these following nodes, a node representing an instruction that reuses a register allocated to an instruction represented by the preceding node. It adds directed edges from these following nodes except the selected following node to the selected following node. Then, the order determination unit 110 computes the number of registers further allocated to or released by each instruction in the program. It stores the numbers in association with corresponding nodes on the order constraint graph to prepare for determination of the execution order.

In order for the instruction detection unit 130 to quickly detect the combination of instructions, the order determination unit 110 also initializes Gen and Kill. Gen is a set of instructions for which the execution order has been determined and which require a new register allocated to it, whereas Kill is a set of instructions for which the execution order has not been determined and which release a register. For example, the order determination unit 110 initializes Gen as an empty set and Kill as all instructions that release a register in the program.

The order determination unit 110 determines the execution order for each of the instructions based on the order constraint graph (S220). For example, on the order constraint graph, the order determination unit 110 selects a node where the execution order has been determined for all its preceding nodes. It then determines the execution order so that an instruction represented by the selected node is executed next to the instructions with their execution order determined. If there are a plurality of nodes to be selected, the order determination unit 110 may, for example, select an instruction that requires the maximum latency from the instructions represented by those nodes and determine the execution order. The latency is the duration of execution of an instruction. Then, if the instruction for which the execution order has been just determined is an instruction that requires a further register allocated to it, the order determination unit 110 adds the instruction to Gen. If the instruction is an instruction that releases a register, the order determination unit 110 deletes the instruction from Kill.

Based on the order constraint graph, the unit for analyzing the number of registers 120 analyzes the number of required registers, which is the number of registers that will be required when instructions with their execution order determined are executed (S230). For example, when an instruction to be executed first in the program has been determined, the unit for analyzing the number of registers 120 sets the number of required registers to the number of registers allocated to that instruction. Then, each time the execution order has been determined for an instruction, the unit for analyzing the number of registers 120 adds the number of further registers allocated to that instruction to the number of required registers, or subtracts the number of registers released by that instruction from the number of required registers.

If the number of required registers does not exceed a predetermined number of registers (S240: NO), the unit for analyzing the number of registers 120 determines whether the execution order has been determined for all instructions in the program (S250). If the execution order has been determined for all instructions, the compiler 10 terminates the processing. If the execution order for any instruction has not been determined, the compiler 10 transfers the processing to S220.

On the other hand, if the number of required registers has exceeded the predetermined number of registers (S240: YES), the instruction detection unit 130 detects a combination of two instructions from undetermined-order instructions in Gen and determined-order instructions in Kill: the combination requires that a node representing an undetermined-order instruction be unable to reach a node representing an determined-order instruction (S260). That is, the instruction detection unit detects a combination of instructions that meets the following conditions: one of the two instructions is a determined-order instruction for which the execution order has been determined by the order determination unit 110 and which requires a new register; the other instruction is an undetermined-order instruction for which the execution order has not been determined by the order determination unit 110 and which releases a register allocated to it; and the order constraint information does not include an order constraint that the one instruction should be executed before the other instruction.

If a plurality of combinations of instructions that meet the above conditions are detected, the instruction detection unit 130 selects from the plurality of combinations a combination that minimizes the sum of the depth of order constraint from the start point of the program to the undetermined-order instruction and the depth of order constraint from the determined-order instruction to the end point of the program.

The order determination reprocessing unit 140 generates a directed edge from the node representing the other instruction to the node representing the one instruction on the order constraint graph. This adds a constraint that the one instruction should be executed next to the other instruction to the order constraint information (S270).

Then, the order determination reprocessing unit 140 changes the state of the one instruction and all instructions to be executed after the one instruction in the order constraint information into the state in which the execution order has not been determined (S280). Also, if these instructions for which the state has been changed into the undetermined-order state are instructions that requires a further register allocated to it, the order determination reprocessing unit 140 deletes the instructions from Gen. If these instructions is instructions that release a register, the order determination reprocessing unit 140 adds the instruction to Kill. The compiler 10 then transfers the processing to S220 and causes the order determination unit 110 to determine the execution order so that the undetermined-order instruction is executed next to the determined-order instruction.

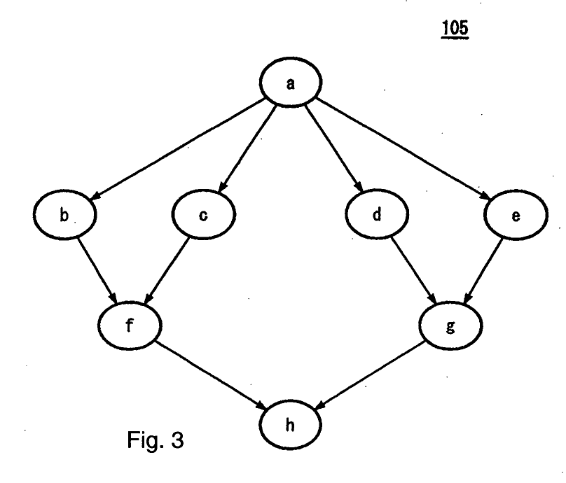

FIG. 3 shows an exemplary order constraint graph stored in the order constraint graph storage unit 105 by the order constraint obtaining unit 100. Circles denoted as a through h are nodes on the order constraint graph representing instructions a through h, respectively. Arrows connecting the nodes indicate directed edges on the order constraint graph. That is, in the example of this figure, the order constraint obtaining unit 100 obtains order constraint information including: an order constraint that the instruction a should be followed by execution of any of the instructions b through e; an order constraint that the instructions b and c should be followed by execution of the instruction f; an order constraint that the instructions d and e should be followed by execution of the instruction g; and an order constraint that the instructions f and g should be followed by execution of the instruction h. This order constraint information is stored in the order constraint graph storage unit 105.

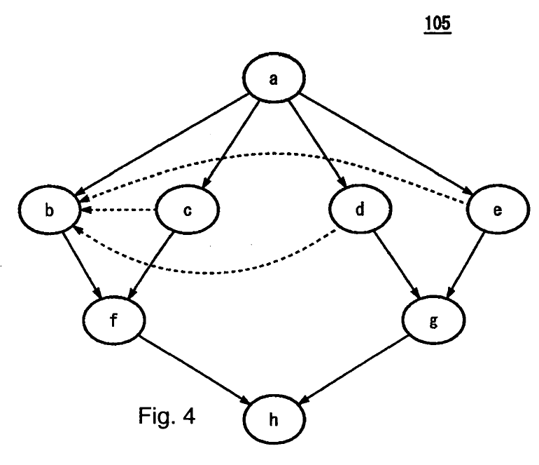

FIG. 4 shows exemplary order constraints added by the order determination unit 110. The order determination unit 110 detects a preceding node followed by a plurality of nodes on the order constraint graph shown in FIG. 3: for example, it detects the node a. Then, from the nodes following the node a, for example, from the nodes b through e, the order determination unit 110 selects the node b representing an instruction that reuses a register allocated to an instruction represented by the node a. The order determination unit 110 adds directed edges respectively from the following nodes except the node b, that is, from the nodes c through e, to the node b. In this figure, arrows of dotted lines indicate the exemplary order constraints added by the order determination unit 110.

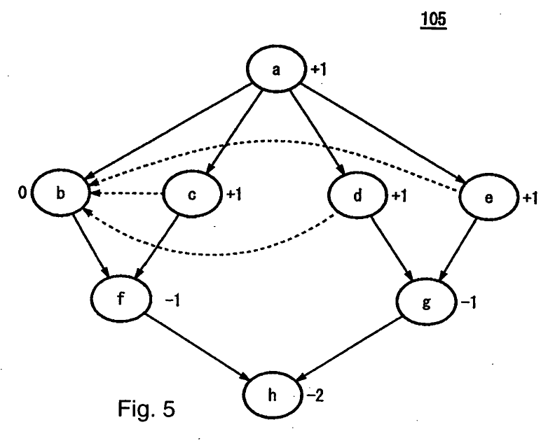

FIG. 5 shows an example of the number of required registers analyzed by the order determination unit 110. The order determination unit 110 computes the number of registers further allocated to or released by each instruction in the program based on the order constraint graph shown in FIG. 4. It stores the numbers in the order constraint graph storage unit 105 in association with the corresponding nodes on the order constraint graph. This figure shows the numbers of registers to be further allocated as positive numbers and the numbers of registers to be released as negative numbers, each number associated with the corresponding node.

For example, the instruction a is an “allocate” instruction to which a new register is allocated for storing the result of the instruction a. Each of the instructions c through e is an allocate instruction to which a further register different from the register allocated to the instruction a is allocated for storing the result of that instruction. The instruction b does not require a new register allocated to it, because it is the last instruction that uses the value of the register allocated to the instruction a and it reuses that register.

The instruction f performs processing using the results of the instructions b and c, and stores the processing result in a register that has been storing the result of either the instruction b or c. Therefore, the instruction f is a “release” instruction that releases one register. Similarly, the instruction g performs processing using the results of d and e, and stores the processing result in a register that has been storing the result of either the instruction d ore. Therefore, the instruction g is a release instruction that releases one register. The instruction h performs processing using the results of the instructions f and g, and terminates the program. Therefore, the instruction h is a release instruction that releases two registers.

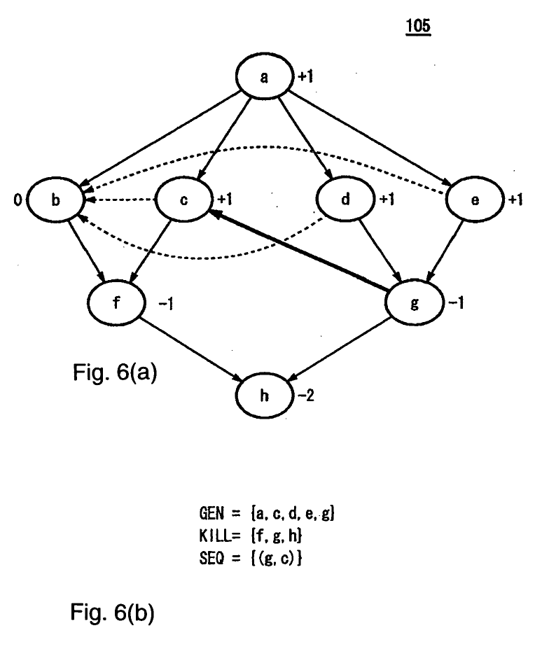

FIG. 6(a) shows an exemplary order constraint added by the order determination reprocessing unit 140. FIG. 6(b) shows a set of allocate instructions to which a further register is allocated, and a set of release instructions that release a register. These figures will be described for the case where the order determination unit 110 refers to the order constraint graph shown in FIG. 4 and determines the execution order such that the instructions a, c, d, and e are sequentially executed in this order. The unit for analyzing the number of registers 120 analyzes the number of required registers based on the order constraint graph shown in FIG. 5 when the execution order has been determined for each instruction. For example, when the execution order has been determined for the instructions a, c, and d, the unit for analyzing the number of registers 120 analyzes the number of required registers as one, two, and three, respectively. When the execution order for the instruction e has been determined, the unit for analyzing the number of registers 120 analyzes the number of required registers as four. It therefore determines that three, a predetermined number of registers, has been exceeded.

The instruction detection unit 130 detects the instruction g from the set of release instructions KILL, as an example of the other instruction according to the invention that releases a register and for which the execution order has not been determined. It also detects the instruction c from the set of allocate instructions GEN, as an example of the one instruction according to the invention to which a further register is allocated and for which the execution order has been determined. Further, the instruction detection unit 130 determines that the instruction c cannot reach the instruction g on the order constraint graph shown in FIG. 4. It is to be noted that the instruction c being unable to reach the instruction g refers to the state in which the instruction c cannot reach the instruction g via any routes that pass through nodes along arrows of directed edges.

Then, the order determination reprocessing unit 140 generates a directed edge from the node g to the node c, thereby adding an order constraint that the instruction c should be executed next to the instruction g to the order constraint information. In the figure, a bold arrow indicates the directed edge added by the order determination reprocessing unit 140. The figure also shows a set of added new order constraints, SEQ. The order determination reprocessing unit 140 changes the state of the determined-order instruction c into the state in which the execution order has not been determined and causes the order determination unit 110 to continue determination of the execution order.

Instead of the above processing, the instruction detection unit 130 may detect, as the one instruction, an instruction to be executed before the determined-order instruction to which a new register is allocated. That is, the instruction detection unit 130 may detect, as the one instruction, an instruction that will allow reduction in the number of required registers if the state of the following instructions is changed into the state in which the execution order has not been determined.

If a plurality of combinations of an undetermined-order instruction and a determined-order instruction are detected, the instruction detection unit 130 selects a combination that minimizes the sum of the depth of order constraint from the instruction a, the start point of the program, to the undetermined-order instruction and the depth of order constraint from the determined-order instruction to the instruction h, the end point of the program. Then, a directed edge is added between the undetermined-order instruction and the determined-order instruction of the selected combination. Here, the depth of order constraint may be, for example, the number of nodes between the start and end of an order constraint. For example, the constraint from the node a to the node g passes through the node d, so that the depth of order constraint is one. The instruction detection unit 130 may also use different depths of order constraint depending on the type of processing in nodes passed through. Alternatively, the depth of order constraint may be the number of directed edges between the start and end of an order constraint.

The order determination reprocessing unit 140 may also generate directed edges for all the plurality of combinations detected by the instruction detection unit 130, so that each directed edge originates from a node representing the determined-order instruction and leads to a node representing the undetermined-order instruction of the corresponding combination. In this case, the order determination reprocessing unit 140 may select directed edges to be added to prevent a circulation from being formed on the order constraint graph by added directed edges. In addition, the order determination reprocessing unit 140 may select directed edges to be added to prevent redundancy of added directed edges. Alternatively, the instruction detection unit 130 may select and detect only combinations of instructions that can be added.

Thus, when the number of required registers exceeds a predetermined number in the process of determining the execution order of instructions, the compiler 10 cancels the execution order once determined and reprocesses the determination of the execution order. Here, the compiler 10 reduces the number of required registers by adding new order constraints while maintaining obtained order constraint information. Therefore, the compiler 10 can reduce the number of required registers while exploiting the optimization effect of determination of the execution order, thereby providing fast operation of the program to be compiled. Further, the compiler 10 can reduce the time required for compiling by performing the processing for adding order constraints concurrently with the processing for determining the execution order.

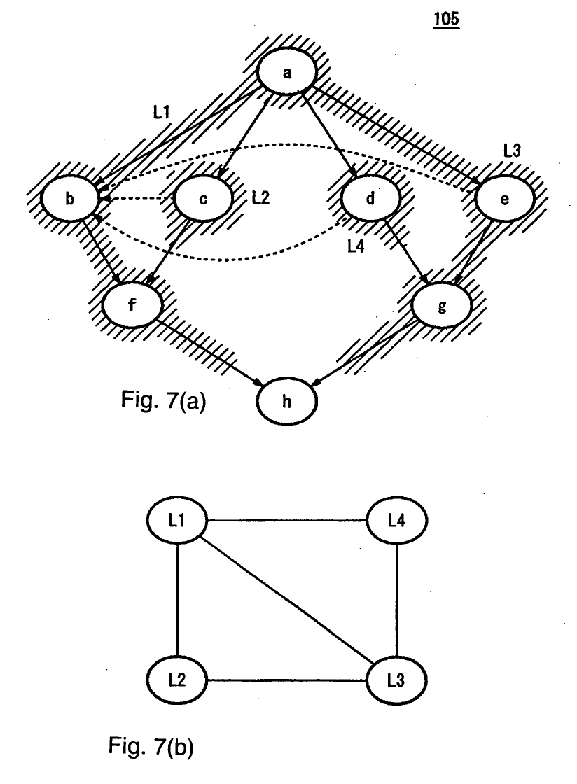

FIG. 7(a) shows exemplary determination of the execution order of instructions in a first alternative example. The compiler in this example detects sets of instructions that can use the same register based on the order constraint graph shown in FIG. 4. For example, the compiler in this example detects L1, a set of instructions that can use the same register: the set L1 includes the instructions a, b, and f, and processing for providing the processing result of these instructions to the instruction h. Similarly, the compiler detects L2, a set of instructions that can use the same register: the set L2 includes the instruction c and processing for providing the processing result of the instruction c to the instruction f. The compiler also detects L3, a set of instructions that can use the same register: the set L3 includes the instructions e and g, and processing for providing the processing result of these instructions to the instruction h. The compiler also detects L4, a set of instructions that can use the same register: the set L4 includes the instruction d and processing for providing the processing result of the instruction d to the instruction g.

FIG. 7(b) shows a graph indicating whether the sets of instructions in the first alternative example can share the registers. The compiler 10 generates this interference graph, which represents each set of instructions as a node and each relationship between nodes that cannot share a register as an edge. For example, the instruction sequence in L1 cannot use any of the registers used in L2, L3, or L4. The instruction sequence in L2 can use the register used in L4, but cannot use the register used in L3. The instruction sequence in L3 cannot use the register used in L4.

The compiler colors the entire graph shown in the figure with a minimum number of colors using different colors for adjacent nodes. As a result, the compiler detects that the total number of registers used in the entire program can be limited to three by allowing L2 and L4 to use the same register. For example, the compiler can allow L2 and L4 to use the same register by determining the execution order of all instructions in L2 and then starting determination of the execution order of instructions in L4, or by determining the execution order of all instructions in L4 and then starting determination of the execution order of instructions in L2.

However, even by using the information shown in these figures, the compiler may require registers more than three, which is the predetermined number of registers, as will be described below. By way of example, this will be described for the case where the compiler determines the execution order according to the technique described in the non-patent literature 1. Based on the order constraint graph shown in FIG. 7(a), the compiler determines the execution order of the instructions c and e so that they are executed in this order. The compiler then attempts to determine the execution order of the instruction d. However, according to the result of graph coloring shown in the figure, the compiler cannot determine the execution order of the instruction d because the execution order of the instruction f, which uses the value of the instruction c, has not been determined. Further, the compiler cannot determine the execution order of the instruction b because the execution order of all instructions preceding the instruction b has not been determined. That is, the compiler cannot determine the execution order of the instructions in the program while maintaining the number of required registers below the predetermined number of registers.

In contrast, the compiler 10 according to the invention changes the state of a determined-order instruction into the state in which the execution order has not been determined as needed. Therefore, the compiler 10 can determine the execution order of the instructions in the program while maintaining the number of required registers below the predetermined number of registers.

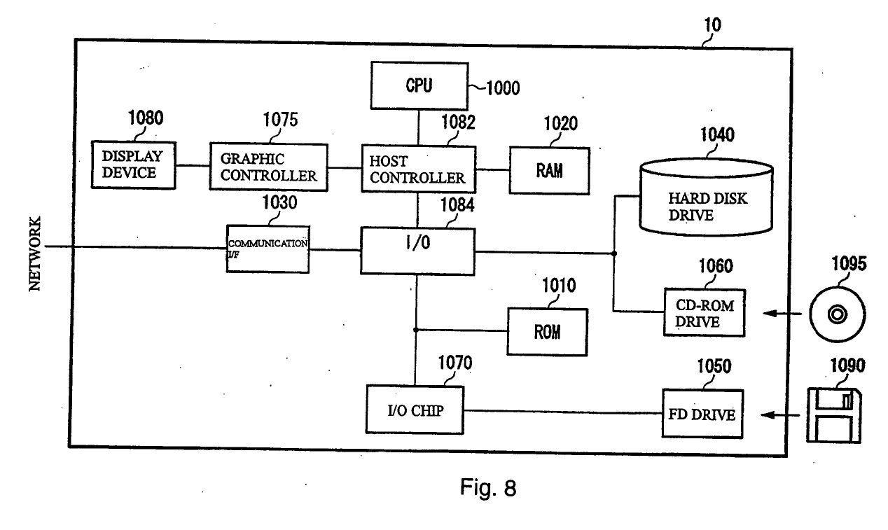

FIG. 8 shows an exemplary hardware configuration of the compiler 10 according to the embodiment. The compiler 10 according to the embodiment or variations of the embodiment includes a CPU peripheral section, in which a CPU 1000, RAM 1020, a graphic controller 1075, and a display device 1080 are interconnected by a host controller 1082. The compiler 10 also includes an input/output section, in which a communication interface 1030, a hard disk drive 1040, and a CD-ROM drive 1060 are connected to the host controller 1082 by an input/output controller 1084. The compiler 10 also includes a legacy input/output section, in which ROM 1010, a flexible disk drive 1050, and an input/output chip 1070 are connected to the input/output controller 1084.

The host controller 1082 provides connection to the RAM 1020 from the CPU 1000 and the graphic controller 1075, which access the RAM 1020 at a high transfer rate. The CPU 1000 operates according to a compiler program stored in the ROM 1010 and the RAM 1020 to control various sections. The graphic controller 1075 obtains image data generated such as by the CPU 1000 in a frame buffer provided in the RAM 1020 and causes the display device 1080 to display the image data. Alternatively, the graphic controller 1075 may have an internal frame buffer for storing image data generated such as by the CPU 1000.

The input/output controller 1084 provides connection between the host controller 1082 and the communication interface 1030, the hard disk drive 1040, and the CD-ROM drive 1060, which are input/output devices of relatively high speed. The communication interface 1030 communicates with other apparatus over networks. The hard disk drive 1040 stores a compiler program and data used by the compiler 10. The CD-ROM drive 1060 reads a compiler program or data from a CD-ROM 1095 and provides it to the input/output chip 1070 through the RAM 1020.

Also connected to the input/output controller 1084 are the ROM 1010, as well as input/output devices of relatively low speed, such as the flexible disk drive 1050 and the input/output chip 1070. The ROM 1010 stores programs such as a boot program executed by the CPU 1000 on activation of the compiler 10 and programs that depend on hardware of the compiler 10. The flexible disk drive 1050 reads a compiler program or data from a flexible disk 1090 and provides it to the input/output chip 1070 through the RAM 1020. The input/output chip 1070 connects the flexible disk 1090, as well as various input/output devices, for example, through a parallel port, a serial port, a keyboard port, or a mouse port.

The compiler program to be provided to the compiler 10 is stored on a recording medium such as the flexible disk 1090, the CD-ROM 1095, or an IC card, and provided by a user. The compiler program is read from the recording medium, installed on the compiler 10 through the input/output chip 1070, and executed on the compiler 10.

The compiler program installed and executed on the compiler 10 includes an order constraint information obtaining module, an order determination module, a module for analyzing the number of registers, an instruction detection module, and an order determination reprocessing module. Description of processing that each module causes the compiler 10 to perform will be omitted, since it is the same as the processing of the corresponding unit in the compiler 10 described in FIGS. 1 through 7.

The above described programs or modules may be stored in external recording media. Besides the flexible disk 1090 and the CD-ROM 1095, the recording media may include optical recording media such as DVD and PD, magneto-optical recording media such as MD, tape media, and semiconductor memory such as IC cards. In addition, the recording media may include storage such as a hard disk or RAM provided in a server system connected to a network such as a dedicated communication network or the Internet. Then, the compiler program may be provided to the compiler 10 over the network.

Thus, the invention has been described according to an embodiment of it. However, the technical scope of the invention is not limited to the scope described in the above embodiment, but various modifications and improvements may be made to the embodiment. It is therefore apparent from description in the claims that these modifications and improvements fall within the technical scope of the invention.

According to the above described embodiment, a compiler, a compiler program, a recording medium, and a compiling method set forth in the following items are provided.

(item 1) A compiler that optimizes a program to be compiled by changing the execution order of instructions in the program, the compiler comprising: an order constraint information obtaining unit that obtains order constraint information indicating order constraints defined among a plurality of instructions in the program, the order constraints defining the order in which the instructions should be executed; an order determination unit that sequentially determines the execution order for each of the plurality of instructions based on the order constraint information; a unit for analyzing the number of registers that analyzes the number of required registers, which is the number of registers that will be required when the instructions with its execution order determined among the plurality of instructions are executed; an instruction detection unit that detects a combination of two instructions, in which one instruction is a determined-order instruction for which the execution order has been determined by the order determination unit, the other instruction is an undetermined-order instruction for which the execution order has not been determined by the order determination unit, and the order constraint information does not include a constraint that the one instruction should be executed before the other instruction; and an order determination reprocessing unit that, when the number of required registers exceeds a predetermined number, changes the state of the one instruction into the state in which the execution order has not been determined and causes the order determination unit to determine the execution order so that the one instruction is executed next to the other instruction.

(item 2) The compiler according to item 1, wherein the instruction detection unit detects an instruction that releases a register as the other instruction, and an instruction that requires a new register allocated to it as the one instruction.

(item 3) The compiler according to item 1, wherein the instruction detection unit detects an instruction that releases a register as the other instruction, and an instruction to be executed before a determined-order instruction that requires a new register allocated to it as the one instruction, and the order determination reprocessing unit further changes the state of all instructions to be executed after the determined-order instruction in the order constraint information into the state in which the execution order has not been determined.

(item 4) The compiler according to item 1, wherein when a plurality of combinations of the one instruction and the other instruction are detected by the instruction detection unit, the order determination reprocessing unit selects from the plurality of combinations a combination that minimizes the sum of the depth of order constraint from a start point of the program to the other instruction and the depth of order constraint from the one instruction to an end point of the program, and the order determination reprocessing unit causes the order determination unit to determine the execution order using the other instruction and the one instruction included in the selected combination.

(item 5) The compiler according to item 1, wherein when the number of required registers exceeds the predetermined number, the order determination reprocessing unit adds an order constraint that the determined-order instruction should be executed next to the undetermined-order instruction to the order constraint information, and thereby causes the order determination unit to determine the execution order so that the determined-order instruction is executed next to the undetermined-order instruction.

(item 6) The compiler according to item 5, wherein the order constraint information obtaining unit obtains, as the order constraint information, an order constraint graph that represents each instruction in the program as a node and order constraints under which instructions should be executed as directed edges, the order determination unit determines the execution order based on the order constraint graph so that an instruction represented by a start node of a directed edge is executed before an instruction represented by an end node of the directed edge, the instruction detection unit detects that the order constraint information does not include an order constraint that the one instruction should be executed before the other instruction by detecting a combination of two instructions in which a node representing the one instruction cannot reach a node representing the other instruction on the order constraint graph, and the order determination reprocessing unit adds an order constraint that the other instruction should be executed next to the one instruction to the order constraint information by generating a directed edge from the node representing the undetermined-order instruction to the node representing the other instruction.

(item 7) A compiler program for causing a computer to function as a compiler that optimizes a program to be compiled by changing the execution order of instructions in the program, wherein the compiler program causes the computer to function as: an order constraint information obtaining unit that obtains order constraint information indicating order constraints defined among a plurality of instructions in the program, the order constraints defining the order in which the instructions should be executed; an order determination unit that sequentially determines the execution order for each of the plurality of instructions based on the order constraint information; a unit for analyzing the number of registers that analyzes the number of required registers, which is the number of registers that will be required when the instructions with its execution order determined among the plurality of instructions are executed; an instruction detection unit that detects a combination of two instructions, in which one instruction is a determined-order instruction for which the execution order has been determined by the order determination unit, the other instruction is an undetermined-order instruction for which the execution order has not been determined by the order determination unit, and the order constraint information does not include a constraint that the one instruction should be executed before the other instruction; and an order determination reprocessing unit that, when the number of required registers exceeds a predetermined number, changes the state of the one instruction into the state in which the execution order has not been determined and causes the order determination unit to determine the execution order so that the one instruction is executed next to the other instruction.

(item 8) The compiler program according to item 7, wherein the instruction detection unit detects an instruction that releases a register as the other instruction, and an instruction that requires a new register allocated to it as the one instruction.

(item 9) The compiler program according to item 7, wherein when the number of required registers exceeds the predetermined number, the order determination reprocessing unit adds an order constraint that the one instruction should be executed next to the other instruction to the order constraint information, and thereby causes the order determination unit to determine the execution order so that the one instruction is executed next to the other instruction.

(item 10) A recording medium with the compiler program according to any of items 7 through 9 recorded on it.

(item 11) A compiling method for optimizing a program to be compiled by changing the execution order of instructions in the program with a computer, the method comprising: an order constraint information obtaining step of obtaining order constraint information indicating order constraints defined among a plurality of instructions in the program, the order constraints defining the order in which the instructions should be executed; an order determination step of sequentially determining the execution order for each of the plurality of instructions based on the order constraint information; a number of registers analyzing step of analyzing the number of required registers, which is the number of registers that will be required when the instructions with its execution order determined among the plurality of instructions are executed; an instruction detection step of detecting a combination of two instructions, in which one instruction is a determined-order instruction for which the execution order has been determined by the order determination unit, the other instruction is an undetermined-order instruction for which the execution order has not been determined by the order determination unit, and the order constraint information does not include a constraint that the one instruction should be executed before the other instruction; and an order determination reprocessing step of, when the number of required registers exceeds a predetermined number, changing the state of the one instruction into the state in which the execution order has not been determined and causing the order determination unit to determine the execution order so that the one instruction is executed next to the other instruction.

In the drawings and specifications there has been set forth a preferred embodiment of the invention and, although specific terms are used, the description thus given uses terminology in a generic and descriptive sense only and not for purposes of limitation.

What is claimed is:

1. A compiler that optimizes a program to be compiled by changing the execution order of instructions in the program, the compiler comprising:
an order constraint information obtaining unit that obtains order constraint information indicating order constraints defined among a plurality of instructions in the program, the order constraints defining the order in which the instructions should be executed;
an order determination unit that sequentially determines the execution order for each of the plurality of instructions based on the order constraint information;
a unit for analyzing the number of registers that analyzes the number of required registers, which is the number of registers that will be required when the instructions with its execution order determined among the plurality of instructions are executed;
an instruction detection unit that detects a combination of two instructions, in which one instruction is a determined-order instruction for which the execution order has been determined by the order determination unit, the other instruction is an undetermined-order instruction for which the execution order has not been determined by the order determination unit, and the order constraint information does not include a constraint that the one instruction should be executed before the other instruction; and
an order determination reprocessing unit that, when the number of required registers exceeds a predetermined number, changes the state of the one instruction into the state in which the execution order has not been determined and causes the order determination unit to determine the execution order so that the one instruction is executed next to the other instruction.

2. The compiler according to claim 1, wherein the instruction detection unit detects an instruction that releases a register as the other instruction, and an instruction that requires a new register allocated to it as the one instruction.

3. The compiler according to claim 1, wherein the instruction detection unit detects an instruction that releases a register as the other instruction, and an instruction to be executed before a determined-order instruction that requires a new register allocated to it as the one instruction, and the order determination reprocessing unit further changes the state of all instructions to be executed after the determined-order instruction in the order constraint information into the state in which the execution order has not been determined.

4. The compiler according to claim 1, wherein when a plurality of combinations of the one instruction and the other instruction are detected by the instruction detection unit, the order determination reprocessing unit selects from the plurality of combinations a combination that minimizes the sum of the depth of order constraint from a start point of the program to the other instruction and the depth of order constraint from the one instruction to an end point of the program, and the order determination reprocessing unit causes the order determination unit to determine the execution order using the other instruction and the one instruction included in the selected combination.

5. The compiler according to claim 1, wherein when the number of required registers exceeds the predetermined number, the order determination reprocessing unit adds an order constraint that the determined-order instruction should be executed next to the undetermined-order instruction to the order constraint information, and thereby causes the order determination unit to determine the execution order so that the determined-order instruction is executed next to the undetermined-order instruction.

6. The compiler according to claim 5, wherein the order constraint information obtaining unit obtains, as the order constraint information, an order constraint graph that represents each instruction in the program as a node and order constraints under which a plurality of instructions should be executed as directed edges, the order determination unit determines the execution order based on the order constraint graph so that an instruction represented by a start node of a directed edge is executed before an instruction represented by an end node of the directed edge, the instruction detection unit detects that the order constraint information does not include an order constraint that the one instruction should be executed before the other instruction by detecting a combination of two instructions in which a node representing the one instruction cannot reach a node representing the other instruction on the order constraint graph, and the order determination reprocessing unit adds an order constraint that the other instruction should be executed next to the one instruction to the order constraint information by generating a directed edge from the node representing the undetermined-order instruction to the node representing the other instruction.

7. A compiler program for causing a computer to function as a compiler that optimizes a program to be compiled by changing the execution order of instructions in the program, wherein the compiler program causes the computer to function as:
an order constraint information obtaining unit that obtains order constraint information indicating order constraints defined among a plurality of instructions in the program, the order constraints defining the order in which the instructions should be executed;
an order determination unit that sequentially determines the execution order for each of the plurality of instructions based on the order constraint information;
a unit for analyzing the number of registers that analyzes the number of required registers, which is the number of registers that will be required when the instructions with its execution order determined among the plurality of instructions are executed;
an instruction detection unit that detects a combination of two instructions, in which one instruction is a determined-order instruction for which the execution order has been determined by the order determination unit, the other instruction is an undetermined-order instruction for which the execution order has not been determined by the order determination unit, and the order constraint information does not include a constraint that the one instruction should be executed before the other instruction; and
an order determination reprocessing unit that, when the number of required registers exceeds a predetermined number, changes the state of the one instruction into the state in which the execution order has not been determined and causes the order determination unit to determine the execution order so that the one instruction is executed next to the other instruction.

8. The compiler program according to claim 7, wherein the instruction detection unit detects an instruction that releases a register as the other instruction, and an instruction that requires a new register allocated to it as the one instruction.

9. The compiler program according to claim 7, wherein when the number of required registers exceeds the predetermined number, the order determination reprocessing unit adds an order constraint that the one instruction should be executed next to the other instruction to the order constraint information, and thereby causes the order determination unit to determine the execution order so that the one instruction is executed next to the other instruction.

10. A recording medium with the compiler program according to claim 7 recorded on it.

11. A compiling method for optimizing a program to be compiled by changing the execution order of instructions in the program with a computer, the method comprising:
obtaining order constraint information indicating order constraints defined among a plurality of instructions in the program, the order constraints defining the order in which the instructions should be executed;
sequentially determining the execution order for each of the plurality of instructions based on the order constraint information;
analyzing the number of required registers, which is the number of registers that will be required when the instructions with its execution order determined among the plurality of instructions are executed;
detecting a combination of two instructions, in which one instruction is a determined-order instruction for which the execution order has been determined by the order determination unit, the other instruction is an undetermined-order instruction for which the execution order has not been determined by the order determination unit, and the order constraint information does not include a constraint that the one instruction should be executed before the other instruction; and
when the number of required registers exceeds a predetermined number, changing the state of the one instruction into the state in which the execution order has not been determined and causing the order determination unit to determine the execution order so that the one instruction is executed next to the other instruction.
